(19) United States
(12) Patent Application Publication
(10) Pub. No.: US 2005/0053680 A1
(43) Pub. Date: Mar. 10, 2005

(54) Pediculicidal compound

(76) Inventor: Shaun Hopkins, Powys Wales (GB)

Correspondence Address: Marc E Brown;McDermott Will & Emery, Suite 3400, 2049 Century Park East, Los Angeles, CA, 90067, US

(21) Appl. No.: 10/501,272

(22) PCT Filed: Jan. 10, 2003
(86) PCT No.: PCT/GB03/00061

(30) Foreign Application Priority Data
Jan. 10, 2002 (GB) 0200502.3

(51) Int. Cl. A01N 25/00; A01N 65/00

(52) U.S. Cl. 424/761

(57) ABSTRACT

There is provided a novel composition containing extract from Melia azadirachta and a surfactant, preferably cetrimonium chloride to repel and/or treat head lice infestation in humans. The composition can be regularly applied although a single overnight application has proven to be virtually 100% effective in killing both adult lice and more importantly, louse eggs.

The present invention relates to compounds or compositions particularly suitable for the treatment and prevention of the human head lice, Pediculus humanis capitas, as well as other types of lice such as, but not limited to the clothing lice, Pediculus humanus humanus.

In general, head lice persists in both developed and underdeveloped countries despite the availability of modern chemical insecticide treatments, public health education, and community based programs of lice eradication. This is often due to a combination of factors. Moreover, there is a school of thought that somehow head lice is a result of bad personal hygiene. This is certainly not the case, as even individuals with a good habit of washing their hair daily may still succumb to a Pediculus infestation.

Typically the control of infections with head lice has been performed using conventional insecticides. A common example is the use of pyrethrins. Pyrethrins act by rapidly incapacitating insects, often known as “knockdown”. Provided that sufficient material is present, the knockdown effect persists until the eventual death of the insect. Normally the effect of the pyrethrins is enhanced or synergised by the addition of piperonyl butoxide to incapacitate the enzymes that the insect would otherwise use to detoxify the pyrethrins. Although pyrethrins have been used as a pediculicidal agent world wide for a number of years (typically in the form of a shampoo), this common insecticide in fact shows a minimal level of activity against louse eggs. For instance, see Burgess, L., “Malathion lotions for head lice a less reliable treatment than commonly believed”, Pharm. J. 247: 630-632 (1991). It is believed that the rapid action of the pyrethrins on lice is hindered if there is a prolonged exposure to water and hence why shampoos are believed to be so inadequate. When lice come into contact with large quantities of water they grasp on to the hair reflexively and close their breathing spiracles to avoid being drowned. Since insecticides are really only effective by entry through the spiracles, when the louse closes their spiracles the insecticide has little chance of creating the knockdown effect. Thus, pyrethrins are essentially regarded as being nonovicidal, but nonetheless are still prevalent in the major products currently available for treating a head lice infestation.

Louse eggs are also problematic. The insecticide must make its way through the physical system that is designed to keep out a wide variety of chemical materials and keep water in. The egg shell has a detachable cap that bears a number of air pores that act effectively to exclude fluids, but will allow the passage of gases and it is through these pores that the louse embryo breathes. It is through these very pores that insecticides must also penetrate. Generally the more viscous a fluid is and the greater the surface tension, the less chance of penetration of the egg pores. It is typically believed that aqueous solutions, cream rinses and shampoos have too great a wetting angle for fluid to flow into the pores directly and will only enter if appropriate excipients are included that will wet and allow the solution to flow more readily.

In addition to the physical problems in using the most common insecticides, such as pyrethrins, to treat head lice, there is also evidence that these insecticides are resulting in strains of lice which are in fact resistant to one or more insecticides, including treating agents such as malathion, permethrin, phenothrin and piperonal, to name but a few. There is also great concern amongst the public in using harsh chemicals on for instance, young children, pregnant woman or by individuals that may be particularly susceptible or vulnerable to such chemical use.

In view of the difficulties and concerns outlined above, it is an object of this invention to provide an effective and natural pediculicidal composition for treatment of lice infestations, in particular head lice infestations. It is a further object of this invention to provide a compound or composition which will be effective in the prevention of head lice infestation, which is something that currently available compounds for treating head lice are not believed to accomplish with real effectiveness.

To this end the present invention provides an effective pediculicidal compound or composition containing active ingredients which are both natural and non-toxic to individuals in need of treatment. In particular, the invention relates to a pediculicidal composition comprising Melia azadirachta seed oil, better known as Neem Oil for the prevention and treatment of lice infestation. The oils and other extracts from the Neem tree, Azadhirachta indica, and closely related species, have been used for centuries as repellent and insecticidal agents for controlling various types of pests, including in protecting agricultural crops, animals and human infestations. In addition, a surfactant is also added with the Neem Oil to maximise the pediculicidal effectiveness of the present invention. The surfactant, cetrimonium chloride, is particularly preferred. Cetrimonium chloride which forms part of the preferred compound of the present invention appears to be acting as a synergizer with the Neem Oil to result in a pediculicidal composition that results in virtually 100% kill rate of both adult lice and eggs. Even though Neem oil has been known as an insecticidal agent, the exact mechanism by which Neem Oil works in “knockdown” of insects is not yet fully understood nor has there ever been developed a formulation based on Neem Oil which is virtually 100% effective in eliminating both the lice adults and eggs.

In particular, the invention relates to a pediculicidal compound or composition comprising from about 1% w/w to 1.25% w/w of Neem Oil and from about 0.2% to 0.3% w/w of surfactant, preferably cetrimonium chloride. Most preferably the formulation consists of 1% w/w of Neem oil and 0.26% w/w of cetrimonium chloride. Triethanolamine may be present in amounts from about approximately 0.01% to about 0.06%. In addition other ingredients may be included such as those which may also be acting as synergisers with the Neem Oil to the kill rate of both adult, but more importantly the kill rate of louse eggs such as terpenoids, for example, Tea tree oil (i.e. oil or extract of Melcleuca alternifolia), light liquid paraffin, isopropylalcohol triethanolamine and ceteraryl alcohol (trade name Lauerex CS).

To prevent the tendency of the pediculicidal composition to dry out the skin of the scalp of the patient, an emollient may be incorporated into the compound or composition. Emollients which are particularly preferred are lanolin and polyols such as glycerol, propylene glycol, sorbitol and low molecular weight polymers thereof. Other examples of emollients are vinyl alcohols and polyvinyl pyrrolidone.

It may also be desirable to add ingredients such as fragrances to make the pediculicidal compound or composition more pleasing to the senses. It is preferred that such fragrances be natural in derivation, although it is not believed to be critical to the effectiveness of the present invention. An example of such a desired ingredient would be lavender oil from the Lavandula angustifolia plant. It should be appreciated by the skilled artisan that lavender oil derived from a different species of Lavandula may also be included in the pediculicidal compound of the present invention. The addition of these emollients and fragrances is under the proviso that the effectiveness of the active ingredients, Neem Oil and surfactant (or terpenoid) and isopropyl alcohol is not lowered or harmed.

A preferred compound of the present invention comprises the following formulation:

| Pediculicidal Compound Ingredients | WT % |
|---|---|
| (Formulation UM0095) | ACT |
| Aqua (Water) | 91.155 |
| Cetearyl alcohol | 4 |
| Glyceryl stearate | 2 |
| Melia Azadirachta seed oil (Neem Oil) | 1 |
| Propylene glycol | 0.675 |
| Cetrimonium chloride 26% | 0.26 |
| Melaleuca Alternifolia (Tea Tree) leaf oil | 0.25 |
| Lavandula Angustifolia (Lavender) oil | 0.25 |
| Urtica Dioica (Nettle) extract | 0.2 |
| Methylparaben & Propylparaben & | 0.15 |
| Ethylparaben | |
| Thymus Vulgaris (Thyme) extract | 0.05 |
| Triethanolamine | 0.01 |
| | 100 |

A further formulation of the present invention is as follows:

| Pediculicidal Compound Ingredients | WT % |
|---|---|
| (Formulation UD07813) | ACT |
| Aqua (water) | 91.105 |
| Cetearyl alcohol | 4 |
| Glyceryl stearate | 2 |
| Melia Azadirachta seed oil (Neem Oil) | 1 |
| Propylene glycol | 0.675 |
| Cetrimonium chloride 26% | 0.26 |
| Melaleuca Alternifolia (Tea Tree) leaf oil | 0.25 |
| Lavandula Angustifolia (Lavender) oil | 0.25 |
| Urtica Dioica (Nettle) extract | 0.2 |
| Methylparaben & Propylparaben & | 0.15 |
| Ethylparaben | |
| Thymus Vulgaris (Thyme) extract | 0.05 |
| Triethanolamine | 0.06 |
| | 100 |

It has been found that if lipophilic materials are prepared/presented in Isopropyl alcohol (IPA) that this will further enhance the pediculicidal activity of these ingredients. For example such ingredients would be Laurex CS, glyceryl stearate, Neem Oil, Lavender Oil and Tea Tree Oil in combination with IPA or optionally substituted for ethyl alcohol. IPA (as well as liquid paraffin and ethyl alcohol are dispersing agents for lipophilic materials) is an effective pediculicide in its own right as it is believe that such compounds enters the spiracles of the lice and asphyxiates the adult louse.

It should be appreciated that the “WT % ACT” amounts or quantities do not have to be limited to the specific amounts or quantities listed above. In addition, and as stated above, the ingredients listed in the compound above, such as for example, cetearyl alcohol, Lavundula angustifolia (lavender) oil, Urtica dioica (nettle) extract, Thymus vulgaris (thyme) extract, propylene glycol and trethanolamine may be suitably substituted. As a result of substituting one or more the above ingredients (excluding the substitution of the Neem Oil or surfactant) the skilled person may therefore need to alter or adjust the percentage composition of the other ingredients accordingly.

The number of applications by the infected individual to the scalp with the compound of the present invention is believed to be greatly reduced from previously available remedies and is believed that a single application of the preferred compound listed above may be sufficient to relieve the individual of both adult lice and their eggs.

It should also be appreciated by the skilled artisan that the source or supplier of any of the above ingredients is not believed to be important to the efficacy of the present invention.

A comparison of formulations currently on the market for with the present invention, including contra-indications is found in Table 1.

It should also be noted that governmental regulations of certain countries may place limits on the amounts of the above agents to be included in head lice formulations.

Experimental Embodiment of the Effectiveness of the Invention

Human lice, Pediculus humanus, were obtained from the culture colony maintained by the Medical Entomogy Centre in Fulboum, Cambridgeshire, United Kingdom. Adult female and male lice, in approximately equal numbers were used for pediculicidal experiments. The lice were fed on the morning of the test and allowed a minimum of 4 hours to recover, during which time they were able to excrete excess water imbibed with their blood meal. Lice were counted into batches that were provided with squares of open meshed nylon gauze (tulle), as a substrate upon which to stand, and each batch allocated to a marked 30 millimetre plastic Petri dish.

Louse eggs were obtained by providing actively laying adults with close meshed nylon gauze, as an egg laying substrate over a 48 hour period. After removal of the lice the large pieces of gauze were cut into appropriately sized smaller pieces and allocated on a random basis to marked 90 millimetre plastic Petri dishes.

Test formulations were compared with a water treated Control group. The ingredients of the formulation tested (the so-called “Nice 'N Clear Head Lice Repellent Lotion” either as formulation UM0095 or UD07813) against the Control are provided in Tables 2 through 10.

Pediculicidal Tests

For the test procedure against lice, the gauze bearing the lice was first washed using a 1:15 mixture of Boots (type suitable for frequenting shampooing) and warm tap water. The gauze and insects were then rinsed using approximately 250-300 millilitres of warm (35 Celsius) tap water. They were then placed on a medical tissue dampened with tap water to simulate the moistness of washed hair. Sufficient amount of the preferred formulation of the invention was then applied, using the tip of the finger to just coat the lice and gauze. The lice were then returned to their marked Petri dish. The same procedure was repeated for the other replicate gauze squares in the batch.

Gauze squares bearing lice were incubated under normal maintenance conditions (30° Celsius +/−2° C. and 50%+/−15% relative humidity) until the next day when the record of the mortality was made.

Ovicidal Tests

This test procedure was essentially the same as for the lice apart from the incubation time before recording the results, which was after the eggs in the Control group had complete hatching, approximately 10 day later.

Results

Tests of pediculicidal activity showed that the Nice 'N Clear formulation UM0095 tested was active with an overnight application (Table 3). The activity was such that none of the lice demonstrated any sign of life and the majority of them were highly dehydrated with darkening of the tissues due to rupture of the gut.

A further test was performed in which lice were treated and exposed to the Nice 'N Clear formulation UM0095 for one hour only. The results are located in Table 4.

From the tests it is apparent that the formulation is active against the laboratory lice within a short period of application. However, prolonged application enhances the activity and in practice is more likely to result in elimination of head lice. This is likely because head lice in the wild are normally subjected to a variety of surface active agents used in shampoos and conditioning rinses. In many cases they are also exposed to low does of herbal extracts contained within such preparations or applied deliberately by carers endeavouring to kill the insects.

Overnight applications of the formulations to louse eggs also resulted in a high level of mortality (virtually 100%). Complete inhibition of hatching did occur with the Nice 'N Clear formulation tested. If one or more of the lice started to hatch, this is designated “Half-hatched” in Tables 5 and 10. There were no half-hatched louse eggs visible after application with the Nice 'N Clear formulation of Table 2. “Undeveloped” for purposes of Tables 5 and 10 refer to those eggs where a level of inhibition of development of the louse embryos occurs. The inhibition which is very substantial for the Nice 'N Clear formulations (UM0095 and UD07813) are likely due to penetration of one or more components of the preparation into the egg structure so that it passed across the chronic membrane to inhibit development of the embryo inside.

Individual Ingredient Tests for Pediculicidal Activity

Tests to try to determine the active components of the present invention were first attempted using a series of solutions of each material made up in unspecified solvents. The results are provided in Table 7. The results are surprising as it would not be expected for the pediculicidal activity to be as dramatic as is demonstrated for individual components and moreover that a single application of the formulation left on the subject overnight (or 8-12 hours) resulted in virtually 100% killing of both adults and eggs. This is a vast difference from standard lice treatment products which require multiple applications to have suitable effect on killing the eggs (although this is rarely 100% effective even after multiple applications). Materials made up in light liquid paraffm are marked with an asterisk (*) in Table 7. As stated above, liquid paraffin is a effective pediculide in its own rights because it enters the spiracles of the lice and asphyxiates them. The same activity was observed with the liquid paraffin sample provided as a control (as see bottom of Table 7).

The tests shown in Table 7 show that those materials made up in a water vehicle exerted no real pediculicidal activity and that the most active of these materials was the Nipa sept, a commercial mix of paraben preservatives, a material that actually has minimal real insecticidal activity.

A further series of tests was instituted in which the lipophilic materials were either dispersed in water or else dissolved/partially dissolved in a mixture of propan-2-ol (isopropyl alcohol) and water. Some of these materials could be dispersed in the vehicle by shaking vigorously whereas others could only be dispersed by prior warming and then shaking on a blood mixture for 60 minutes. Even after this treatment, both the Laurex CS (i.e. cetearyl alcohol) and GMS N/SE (i.e. glyceryl stearate) were not dispersed in the water vehicle but formed variable sized lumps in the fluid. The effects of these mixtures on lice are shown in Table 8. Of these samples only the alcohol/water suspensions of Laurex CS and GMS N/SE showed any activity and of these only the former killed all lice and prevented them from laying any eggs. In order to test this activity further the Laurex CS mixture was tested at different time exposures. These showed that some activity can be demonstrated from 30 minutes application (Table 9).

Activity Against Louse Eggs

Tests against louse eggs using the formulation components tested against lice in Table 8 found that activity could be detected for Laurex CS, GMS N/SE and Lavender Oil after correction for the levels of hatching failure in the Control Group (Table 10). Of these three only the Laurex CS could be shown to have had an activity in excess of 50% kill. Only Laurex CS and GMS N/SE had an activity to inhibit the development of the embryo prior to the stage of the development at which the eyespot can be seen through the shell of the louse egg (designated “Undeveloped” in Table 10). This means that these two compounds are able to enter the air pores in the cap of the louse eggshell and disrupt the functioning of the membrane surrounding the developing embryo.

TABLE 1

| | | | Treatment | | |
|---|---|---|---|---|---|
| | ACTIVE INGREDIENT | CONTRA-INDICATIONS | Time | POP* | F |
| NICE ′N CLEAR | NEEM OIL 1% W/W | None | 10 mins | X | X |
| | Cetrimonium Chloride | | | | |
| | .26% W/W | | | | |
| DERBAC-M | MALATHION 0.5% W/W | Under 6 months, Pregnant/Breast feeding, avoid eyes, no | 12 hours | ✓ | X |
| | | repeated use. | | | |
| LYCLEAR | PERMETHRIN 1% W/W | Under 6 months, pregnant/breast feeding, swallowing. | 10 mins | ✓ | X |
| FULL MARKS | PHENOTHRIN 0.2% W/V | Under 6 months, asthma, eczema, swallowing, pregnant/breast | 2 hours | ✓ | ✓ |
| Lotion | | feeding, eyes, repeated use, coloured, bleached, permed, | | | |
| FULL MARKS | PHENOTHRIN 0.5% W/W | Under 6 months, eyes, repeated use, asthma, eczema, | 30 mins | ✓ | ✓ |
| Mousse | | coloured, bleached, permed, pre-rinsed hair, can cause | | | |
| | | skin irritation. | | | |
| PRIODERM | MALATHION 0.5% W/V | Under 6 months, asthma, eczema, eyes, swallowing, | 2 hours + 8-10 | ✓ | ✓ |
| Lotion | | pregnant/breast feeding, repeated use, coloured, bleached, | hours | | |
| | | permed, pre-rinsed. | | | |
| PRIODERM | MALATHION USP 1.0% W/W | Under 6 months, eyes, repeated use, swallowing, pregnant/ | 5 mins | ✓ | X |
| Cream Shampoo | | breast feeding, coloured, bleached, permed, pre-rinsed hair. | 3 times at 3 day | | |
| | | | intervals | | |
| QUELLADA-M | MALATHION 0.5% W/W | Under 6 months, swallowing, can cause skin irritation, eyes, | 12 hours | ✓ | X |
| Liquid | | pregnant/breast feeding, permed, pre-rinsed, coloured, | | | |
| | | bleached hair. | | | |
| QUELLADA-M | MALATHION | Under 6 months, continued prolonged treatment. | 5 mins | ✓ | X |
| Cream Shampoo | | | (Repeat procedure) | | |
| SULEO-M | MALATHION 0.5 W/V | Under 6 months, continued prolonged treatment, asthma, | 2 hours + 8-10 | ✓ | ✓ |
| | | eczema, eyes, swallowing. | hours | | |
| RAPPELL | PIPERONAL | Under 2 years, eyes, swallowing. | Spray On | X | ✓ |
| | | If asthmatic or have sensitive skin use with caution. | | | |
| NATRUCLEAR | TEA-TREE | Eyes | 10 mins | X | X |
| Tea Tree Shampoo | | | | | |
| BIZNIZ | EUCALYPTUS, ROSEMARY, | Under 2 years, epilepsy, pregnant, high blood pressure, eyes, | Approx 10-15 mins: | X | X |
| | LAVENDER OILS LISTED | swallowing. | leave in conditioner | | |
| CHINESE | CHINESE HERBS | | | X | |
| WHISPERS | | | | | |
| ASDA | TEA-TREE & LAVENDER | Details unknown | | | |
| HEADLICE | | | | | |
| REPELLENT | | | | | |
| LOTION | | | | | |
| XIT - | T-tree, lavender, eucalyptus, | Details unknown | Spray on | | |
| Aromatherapy | rosemary, peppermint, west | | | | |
| Spray | Indian bay/essential oils | | | | |
| XIT - Cleanser, | Shampoo = peppermint, | Details unknown | 35-45 mins | | |
| Conditioner & | lavender, eucalyptus, rosemary, | | | | |
| Essetnial Oil blend | west Indian bay/essential oils | | | | |
| liquid | Conditioner = as above + T-Tree | | | | |
| | Essential oil blend = grapeseed, | | | | |
| | wheatgerm, avocado t-tree, | | | | |
| | lavender, eucalyptus oils | | | | |
| NITTY GRITTY - | | Details unknown | | | |
| Aromatherapy | | | | | |
| West Combing Kit | | | | | |
| NITTY GRITTY - | | Details unknown | 12 hours | | |
| Head Lice | | | | | |
| Repellent Spray | | | | | |

*P.O.P = Pharmacy Only Product

TABLE 2
NICE ′N CLEAR HEAD LICE REPELLENT LOTION (UM0095)

| | TRADE | | | | | | ANIMAL | | | WT % |
|---|---|---|---|---|---|---|---|---|---|---|
| RM | NAME | INCI | INCI - HARM | HAZARD | FUNCTION | AD | TESTED | SUPPLIER | WT % | ACT |
| 0238 | Laurex CS; | Cetearyl alcohol | Cetearyl alcohol | NH | Co-stabiliser | N | NEVER | Surfachem | 4 | 4 |
| | Surfac CS; | | | | & emulsifer | | | | | |
| | Ceto-Stearyl | | | | | | | | | |
| | Alcohol | | | | | | | | | |
| 0585 | Dehyquart | Cetrimonium | Cetrimonium | R22, 38, | Cond. & | N | 1978 Dec | Cognis | 1 | 0.26 |
| | A-CA | chloride 26% | chloride 26% | 41 | emulsifier | | | | | |
| 1309 | Tea Tree Oil | Melaleuca | Melaleuca Alternifolia | NH | Natural | N | NEVER | Paroxite | 0.25 | 0.25 |
| | Pharmaceutical | Alternifolia | (Tea Tree) leaf oil | | | | | | | |
| 1348 | Lavender Oil | Lavandula | Lavandula Angustifolia | NH | Natural | N | NEVER | Connock | 0.25 | 0.25 |
| | 40/42 | Angustifolia | (Lavender) oil | | | | | | | |
| 1895 | Nettle Extract | Aqua (water) | Aqua (water 59.4% & | MR36/38 | Natural | N | NEVER | A&E | 1 | 0.6 |
| | | 59.4% & Propylene | Propylene glycol 20% & | | | | | Connock | | 0.2 |
| | | glycol 20% & | Urtica | | | | | | | 0.2 |
| | | Urtica Dioica | Dioica (nettle) | | | | | | | |
| | | (nettle) extract 20% | extract 20% | | | | | | | |
| 1896 | Thyme Extract | Aqua 47.5% & | Water (aqua) 47.5% & | MR36/38 | Natural | N | NEVER | Frag Oil | 1 | 0.475 |
| | 21173 | Propylene glycol | Propylene glycol | | | | | | | 0.475 |
| | | 47.5% & Thymus | 47.5% & Thymus | | | | | | | 0.05 |
| | | Vulgaris (Thyme) | Vulgaris (Thyme) | | | | | | | |
| | | extract 5% | extract 5% | | | | | | | |
| 1897 | Neem Oil | Melia Azadirachta | Melia Azadirachta | NH | Natural | N | 1998 Oct | Natural | 1 | 1 |
| | | seed oil | seed oil | | | | | Science.Com | | |
| | | | | | | | | Ltd | | |
| 0117 | Nipasept | Methylparaben & | Methylparaben & | MR36/ | Preservative | N | 0 | Nipa | 0.15 | 0.15 |
| | | Propylparaben & | Propylparaben & | 38/ing; | | | | | | |
| | | Ethylparaben | Ethylparaben | Dirr | | | | | | |
| 0557 | GMS NSE; | Glyceryl stearate | Glyceryl stearate | NH | Emollient & | N | NEVER | Paroxite; | 2 | 2 |
| | Lasemul | | | | Stabiliser | | | Refined | | |
| | 92N40 | | | | | | | | | |
| 0177 | Tri- | Triethanolamine | Triethanolamine | NH | Buffer | N | 1991 | Basf | 0.01 | |
| | ethanolamine | | | | | | | | | |
| 0288 | Purified | Aqua | Aqua (water) | | | | | | 89.34 | |
| | Water | | | | | | | | 100 | |

TABLE 3
Activity of UM0095 on human lice

| | | Number of lice | | | Mortality % |
|---|---|---|---|---|---|
| Treatment | Replicate | Total | Killed | Moribund | Total (Killed) |
| Nice ′N Clear | 1 | 19 | 19 | 0 | 100 (100) |
| overnight | 2 | 22 | 22 | 0 | |
| | 3 | 19 | 19 | 0 | |
| Control | 1 | 21 | 5 | 0 | 26 (23) |
| | 2 | 17 | 1 | 1 | |
| | 3 | 19 | 7 | 0 | |

TABLE 4
Activity of UM0095 on human lice

| | | Number of lice | | | Mortality % |
|---|---|---|---|---|---|
| Treatment | Replicate | Total | Killed | Moribund | Total (Killed) |
| Nice ′N Clear | 1 | 9 | 1 | 7 | 89 (11) |
| 1 hour | | | | | |

TABLE 5
Activity of UM0095 on louse eggs

| Treatment | | Number of eggs | | | | | |
|---|---|---|---|---|---|---|---|
| & application | Replicate | Total | Hatched | Half-hatched | Undeveloped | Mortality % | Undeveloped % |
| Nice ′N Clear | 1 | 132 | 0 | 0 | 5 | | |
| overnight | 2 | 119 | 1 | 1 | 14 | | |
| | 3 | 157 | 0 | 0 | 1 | | |
| | Total | 408 | 1 | 1 | 20 | 99.8 | 4.9 |
| Control | 1 | 97 | 64 | 1 | 4 | | |
| | 2 | 125 | 66 | 3 | 9 | | |
| | 3 | 136 | 123 | 1 | 4 | | |
| | Total | 358 | 253 | 5 | 17 | 29.3 | 4.7 |

TABLE 6
Activity of UD07813 on human lice

| | | Number of lice | | | | |
|---|---|---|---|---|---|---|
| | | | | Mori- | Mortality % | Number |
| Treatment | Replicate | Total | Killed | bund | Total (Killed) | of eggs |
| Overnight | 1 | 17 | 17 | 0 | | 0 |
| | 2 | 18 | 16 | 2 | | 0 |
| | Total | 35 | 33 | 2 | 100 (94) | 0 |
| Control | 1 | 18 | 1 | 1 | 11 (6) | 35 |

TABLE 7
Activity of UD07813 on lice

| | | Number of lice | | | Mortality % | Number |
|---|---|---|---|---|---|---|
| Treatment | Replicate | Total | Killed | Moribund | Total (Killed) | of eggs |
| Laurex CS 4.00%* | | 19 | 19 | 0 | 100 (100) | 0 |
| GMS N/SE 2.00%* | | 21 | 21 | 0 | 100 (100) | 0 |
| Dehyquart ACA 1.00% | | 20 | 2 | 2 | 20 (10) | 34 |
| Neem Oil 1.00%* | | 20 | 20 | 0 | 100 (100) | 0 |
| Nettle Extract 1.00% | | 21 | 3 | 2 | 24 (14) | 16 |
| Thyme Extract 1.00% | | 19 | 1 | 3 | 21 (5) | 22 |
| Lavender Oil 0.25%* | | 20 | 20 | 0 | 100 (100) | 0 |
| Tea Tree Oil 0.25%* | | 20 | 20 | 0 | 100 (100) | 0 |
| Nipasept 0.15% | | 20 | 3 | 1 | 20 (15) | 16 |
| Triethanolamine 0.06% | | 21 | 5 | 4 | 43 (24) | 16 |
| Liquid Paraffin | | 19 | 19 | 0 | 100 (100) | 0 |
| Water | | 20 | 3 | 1 | 20 (15) | 21 |

TABLE 8
Acitivity of UD07813 on human lice

| | | Number of lice | | | Mortality % | Number |
|---|---|---|---|---|---|---|
| Treatment | Replicate | Total | Killed | Moribund | Total (Killed) | of eggs |
| Laurex CS 4.00% IPA | | 20 | 20 | 0 | 100 (100) | 0 |
| Laurex CS 4.00% H₂O | | 20 | 0 | 0 | 0 | 52 |
| GMS N/SE 2.00% IPA | | 20 | 8 | 0 | 40 (40) | 17 |
| GMS N/SE 2.00% H₂O | | 21 | 2 | 0 | 10 (10) | 59 |
| Neem Oil 1.00% | | 20 | 3 | 2 (1) | 30 (15) | 33 |
| Lavender Oil 0.25% | | 20 | 1 | 0 | 5 (5) | 44 |
| Tea Tree Oil 0.25% | | 20 | 2 | 0 | 10 (10) | 43 |
| IPA/H₂O mix | | 20 | 3 | 2 | 25 (15) | 61 |

TABLE 9
Activity of UD07813 on lice

| | | Number of lice | | | Mortality % | Number |
|---|---|---|---|---|---|---|
| Treatment | Replicate | Total | Killed | Moribund | Total (Killed) | of eggs |
| Laurex CS 4.00% IPA | 30 mins | 22 | 15 | 3 | 82 (68) | 3 |
| Laurex CS 4.00% IPA | 2 hrs | 22 | 18 | 4 | 100 (82) | 0 |
| Laurex CS 4.00% IPA | overnight | 21 | 21 | 0 | 100 (100) | 0 |
| IPA/H₂O mix | 30 mins | 23 | 2 | 0 | 9 (9) | 19 |
| IPA/H₂O mix | 2 hrs | 20 | 2 | 0 | 10 (10) | 23 |
| IPA/H₂O mix | overnight | 20 | 8 | 0 | 40 (40) | 11 |

TABLE 10
Activity of UD07813 on louse eggs

| Treatment | Number of eggs | | | | | |
|---|---|---|---|---|---|---|
| & application | Total | Hatched | Half-hatched | Undeveloped | Mortality % | Undeveloped % |
| Laurex CS 4.00% IPA | 102 | 19 | 1 | 70 | 81.4 (63.7) | 68.6 (47.2) |
| Laurex CS 4.00% H₂O | 163 | 117 | 1 | 34 | 28.2 (0) | 20.9 (0) |
| GMS N/SE 2.00% IPA | 145 | 45 | 1 | 93 | 69.0 (39.5) | 64.1 (39.7) |
| GMS N/SE 2.00% H₂O | 176 | 135 | 7 | 27 | 23.3 (0) | 15.3 (0) |
| Neem Oil 1.00% | 136 | 73 | 6 | 54 | 53.7 (9.6) | 39.7 (0) |
| Lavender Oil 0.25% | 162 | 109 | 2 | 40 | 67.3 (36.1) | 24.7 (0) |
| Tea Tree Oil 0.25% | 166 | 91 | 3 | 56 | 45.2 (0) | 33.7 (0) |
| IPA/H₂O mix | 121 | 62 | 2 | 49 | 48.8 | 40.5 |

FIGURES for mortality of eggs (the overall proportion that failed to hatch) and the proportion that failed to develop (undeveloped) have been adjusted using Abbott's correction for Control group mortality.

1. A pharmaceutical formulation for use in repelling and/or killing human head lice comprising a solution of Neem Oil and a surfactant.

2. A formulation as claimed in claim 1, wherein the solution comprises from about 1% w/w to about 1.25% w/w or Neem Oil and from about 0.2% to about 0.3% w/w of surfactant.

3. A formulation as claimed in claim 1, wherein the surfactant is cetrimonium chloride.

4. A formulation as claimed in claim 1, wherein the cetrimonium chloride is present in the composition at about 0.25% w/w of the compound.

5. A formulation as claimed in claim 1, wherein the composition further comprises trace triethanolamine in an amount of about 0.1% to 0.06% w/w of the composition.

6. A formulation as claimed in claim 1, wherein the composition further comprises isopropyl alcohol.

7. A formulation as claimed in claim 1, wherein the solution further comprises either ethyl alcohol or light liquid paraffin.

8. A formulation as claimed in claim 1, wherein the solution comprises the following formulation
Aqua (water)—91.155%;
Cetearyl alcohol—4%;
Glyceryl stearate—2%;
Melia Azadirachta seed oil (Neem Oil)—1%;
Propylene glycol—0.675%;
Cetrimonium chloride 26%-0.26%;
Melaleuca Alternifolia (Tea Tree) leaf oil—0.25%;
Lavandula Angustifolia (Lavender) oil—0.25%;
Urtica Dioica (Nettle) extract—0.2%;
Methylparaben & Propylparaben & Ethylparaben—0.15%;
Thymus Vulgaris (Thyme) extract—0.05%; and
Tethanolamine—0.01%.

9. A formulation as claimed in claim 1, wherein the solution comprises the following formulation:
Aqua (water)—91.105%;
Cetearyl alcohol—4%;
Glyceryl stearate—2%;
Melia Azadirachta seed oil (Neem Oil)—1%;
Propylene glycol—0.675%;
Cetrimonium chloride 26%-0.26%;
Melaleuca Alternifolia (Tea Tree) leaf oil—0.25%;
Lavandula Angustifolia (Lavender) oil—0.25%;
Urtica Dioica (Nettle) extract—0.2%;
Methylparaben & Propylparaben & Ethylparaben—0.15%;
Thymus Vulgaris (Thyme) extract—0.05%; and
Tethanolamine—0.06%.

10. The user of a formulation as per claim 1 for the manufacture of a medicament for the prevention and treatment of head lice infestation in humans.

11. A formulation as claimed in claim 2, wherein the surfactant is cetrimonium chloride.

12. A formulation as claimed in claim 2, wherein the cetrimonium chloride is present in the composition at about 0.25% w/w of the compound.

13. A formulation as claimed in claim 3, wherein the cetrimonium chloride is present in the composition at about 0.25% w/w of the compound.

14. A formulation as claimed in claim 4, wherein the composition further comprises trace triethanolamine in an amount of about 0.1% to 0.06% w/w of the composition.

15. A formulation as claimed in any one of claim 2, wherein the composition further comprises isopropyl alcohol.

16. A formulation as claimed in any one of claim 3, wherein the composition further comprises isopropyl alcohol.

17. A formulation as claimed in any one of claim 4, wherein the composition further comprises isopropyl alcohol.

18. A formulation as claimed in any one of claim 5, wherein the composition further comprises isopropyl alcohol.

19. A formulation as claimed in any one of claim 2, wherein the solution further comprises either ethyl alcohol or light liquid paraffin.

20. A formulation as claimed in any one of claim 3, wherein the solution further comprises either ethyl alcohol or light liquid paraffin.

21. A formulation as claimed in any one of claim 4, wherein the solution further comprises either ethyl alcohol or light liquid paraffin.

22. A formulation as claimed in any one of claim 5, wherein the solution further comprises either ethyl alcohol or light liquid paraffin.

23. A formulation as claimed in any one of claim 6, wherein the solution further comprises either ethyl alcohol or light liquid paraffin.

24. A formulation as claimed in claim 2, wherein the solution comprises the following formulation:
Aqua (water)—91.155%;
Cetearyl alcohol—4%;
Glyceryl stearate—2%;
Melia Azadirachta seed oil (Neem Oil)—1%;
Propylene glycol—0.675%;
Cetrimonium chloride 26%-0.26%;
Melaleuca Alternifolia (Tea Tree) leaf oil—0.25%;
Lavandula Angustifolia (Lavender) oil—0.25%;
Urtica Dioica (Nettle) extract—0.2%;
Methylparaben & Propylparaben & Ethylparaben—0.15%;
Thymus Vulgaris (Thyme) extract—0.05%; and
Tethanolamine—0.01%.

25. A formulation as claimed in claim 3, wherein the solution comprises the following formulation:
Aqua (water)—91.155%;
Cetearyl alcohol—4%;
Glyceryl stearate—2%;
Melia Azadirachta seed oil (Neem Oil)—1%;
Propylene glycol—0.675%;
Cetrimonium chloride 26%-0.26%;
Melaleuca Alternifolia (Tea Tree) leaf oil—0.25%;
Lavandula Angustifolia (Lavender) oil—0.25%;
Urtica Dioica (Nettle) extract—0.2%;
Methylparaben & Propylparaben & Ethylparaben—0.15%;
Thymus Vulgaris (Thyme) extract—0.05%; and
Tethanolamine—0.01%.

26. A formulation as claimed in claim 4, wherein the solution comprises the following formulation:
Aqua (water)—91.155%;
Cetearyl alcohol—4%;
Glyceryl stearate—2%;
Melia Azadirachta seed oil (Neem Oil)—1%;
Propylene glycol—0.675%;
Cetrimonium chloride 26%-0.26%;
Melaleuca Alternifolia (Tea Tree) leaf oil—0.25%;
Lavandula Angustifolia (Lavender) oil—0.25%;
Urtica Dioica (Nettle) extract—0.2%;
Methylparaben & Propylparaben & Ethylparaben—0.15%;
Thymus Vulgaris (Thyme) extract—0.05%; and
Tethanolamine—0.01%.

27. A formulation as claimed in claim 5, wherein the solution comprises the following formulation:
Aqua (water)—91.155%;
Cetearyl alcohol—4%;
Glyceryl stearate—2%;
Melia Azadirachta seed oil (Neem Oil)—1%;
Propylene glycol—0.675%;
Cetrimonium chloride 26%-0.26%;
Melaleuca Alternifolia (Tea Tree) leaf oil—0.25%;
Lavandula Angustifolia (Lavender) oil—0.25%;
Urtica Dioica (Nettle) extract—0.2%;
Methylparaben & Propylparaben & Ethylparaben—0.15%;
Thymus Vulgaris (Thyme) extract—0.05%; and
Tethanolamine—0.01%.

28. A formulation as claimed in claim 6, wherein the solution comprises the following formulation:
Aqua (water)—91.155%;
Cetearyl alcohol—4%;
Glyceryl stearate—2%;
Melia Azadirachta seed oil (Neem Oil)—1%;
Propylene glycol—0.675%;
Cetrimonium chloride 26%-0.26%;
Melaleuca Alternifolia (Tea Tree) leaf oil—0.25%;
Lavandula Angustifolia (Lavender) oil—0.25%;
Urtica Dioica (Nettle) extract—0.2%;
Methylparaben & Propylparaben & Ethylparaben—0.15%;
Thymus Vulgaris (Thyme) extract—0.05%; and
Tethanolamine—0.01%.

29. A formulation as claimed in claim 7, wherein the solution comprises the following formulation:
Aqua (water)—91.155%;
Cetearyl alcohol—4%;
Glyceryl stearate—2%;
Melia Azadirachta seed oil (Neem Oil)—1%;
Propylene glycol—0.675%;
Cetrimonium chloride 26%-0.26%;
Melaleuca Alternifolia (Tea Tree) leaf oil—0.25%;
Lavandula Angustifolia (Lavender) oil—0.25%;
Urtica Dioica (Nettle) extract—0.2%;
Methylparaben & Propylparaben & Ethylparaben—0.15%;
Thymus Vulgaris (Thyme) extract—0.05%; and
Tethanolamine—0.01%.

30. A formulation as claimed in claim 2, wherein the solution comprises the following formulation:
Aqua (water)—91.105%;
Cetearyl alcohol—4%;
Glyceryl stearate—2%;
Melia Azadirachta seed oil (Neem Oil)—1%;
Propylene glycol—0.675%;
Cetrimonium chloride 26%-0.26%;
Melaleuca Alternifolia (Tea Tree) leaf oil—0.25%;
Lavandula Angustifolia (Lavender) oil—0.25%;
Urtica Dioica (Nettle) extract—0.2%;
Methylparaben & Propylparaben & Ethylparaben—0.15%;
Thymus Vulgaris (Thyme) extract—0.05%; and
Tethanolamine—0.06%.

31. A formulation as claimed in claim 3, wherein the solution comprises the following formulation:
Aqua (water)—91.105%;
Cetearyl alcohol—4%;
Glyceryl stearate—2%;
Melia Azadirachta seed oil (Neem Oil)—1%;
Propylene glycol—0.675%;
Cetrimonium chloride 26%-0.26%;
Melaleuca Alternifolia (Tea Tree) leaf oil—0.25%;
Lavandula Angustifolia (Lavender) oil—0.25%;
Urtica Dioica (Nettle) extract—0.2%;
Methylparaben & Propylparaben & Ethylparaben—0.15%;
Thymus Vulgaris (Thyme) extract—0.05%; and
Tethanolamine—0.06%.

32. A formulation as claimed in claim 4, wherein the solution comprises the following formulation:
Aqua (water)—91.105%;
Cetearyl alcohol—4%;
Glyceryl stearate—2%;
Melia Azadirachta seed oil (Neem Oil)—1%;
Propylene glycol—0.675%;
Cetrimonium chloride 26%-0.26%;
Melaleuca Alternifolia (Tea Tree) leaf oil—0.25%;
Lavandula Angustifolia (Lavender) oil—0.25%;
Urtica Dioica (Nettle) extract—0.2%;
Methylparaben & Propylparaben & Ethylparaben—0.15%;
Thymus Vulgaris (Thyme) extract—0.05%; and
Tethanolamine—0.06%.

33. A formulation as claimed in claim 5, wherein the solution comprises the following formulation:
Aqua (water)—91.105%;
Cetearyl alcohol—4%;
Glyceryl stearate—2%;
Melia Azadirachta seed oil (Neem Oil)—1%;
Propylene glycol—0.675%;
Cetrimonium chloride 26%-0.26%;
Melaleuca Alternifolia (Tea Tree) leaf oil—0.25%;
Lavandula Angustifolia (Lavender) oil—0.25%;
Urtica Dioica (Nettle) extract—0.2%;
Methylparaben & Propylparaben & Ethylparaben—0.15%;
Thymus Vulgaris (Thyme) extract—0.05%; and
Tethanolamine—0.06%.

34. A formulation as claimed in claim 6, wherein the solution comprises the following formulation:
Aqua (water)—91.105%;
Cetearyl alcohol—4%;
Glyceryl stearate—2%;
Melia Azadirachta seed oil (Neem Oil)—1%;
Propylene glycol—0.675%;
Cetrimonium chloride 26%-0.26%;
Melaleuca Alternifolia (Tea Tree) leaf oil—0.25%;
Lavandula Angustifolia (Lavender) oil—0.25%;
Urtica Dioica (Nettle) extract—0.2%;
Methylparaben & Propylparaben & Ethylparaben—0.15%;
Thymus Vulgaris (Thyme) extract—0.05%; and
Tethanolamine—0.06%.

35. A formulation as claimed in claim 7, wherein the solution comprises the following formulation:
Aqua (water)—91.105%;
Cetearyl alcohol—4%;
Glyceryl stearate—2%;
Melia Azadirachta seed oil (Neem Oil)—1%;
Propylene glycol—0.675%;
Cetrimonium chloride 26%-0.26%;
Melaleuca Alternifolia (Tea Tree) leaf oil—0.25%;
Lavandula Angustifolia (Lavender) oil—0.25%;
Urtica Dioica (Nettle) extract—0.2%;
Methylparaben & Propylparaben & Ethylparaben—0.15%;
Thymus Vulgaris (Thyme) extract—0.05%; and
Tethanolamine—0.06%.

36. The user of a formulation as per claim 2 for the manufacture of a medicament for the prevention and treatment of head lice infestation in humans.

37. The user of a formulation as per claim 3 for the manufacture of a medicament for the prevention and treatment of head lice infestation in humans.

38. The user of a formulation as per claim 4 for the manufacture of a medicament for the prevention and treatment of head lice infestation in humans.

39. The user of a formulation as per claim 5 for the manufacture of a medicament for the prevention and treatment of head lice infestation in humans.

40. The user of a formulation as per claim 6 for the manufacture of a medicament for the prevention and treatment of head lice infestation in humans.

41. The user of a formulation as per claim 7 for the manufacture of a medicament for the prevention and treatment of head lice infestation in humans.

42. The user of a formulation as per claim 8 for the manufacture of a medicament for the prevention and treatment of head lice infestation in humans.

43. The user of a formulation as per claim 9 for the manufacture of a medicament for the prevention and treatment of head lice infestation in humans.
